(19) United States
(12) Patent Application Publication
(10) Pub. No.: US 2012/0007378 A1
(43) Pub. Date: Jan. 12, 2012

(54) ROOF MODULE WITH STORAGE ASSEMBLY

(75) Inventors: PETER LENG, MAINZ (DE); JANUSZ LIPKA, WARSAW (PL)

(73) Assignee: DELPHI TECHNOLOGIES, INC., TROY, MI (US)

(21) Appl. No.: 13/164,049

(22) Filed: Jun. 20, 2011

(30) Foreign Application Priority Data
Jul. 9, 2010 (EP) 10169083.2

(51) Int. Cl. B60R 7/04

(52) U.S. Cl. 296/37.8

(57) ABSTRACT

An overhead console for a vehicle interior, comprising a storage module provided with a housing having an aperture, a cover pivotally mounted on the housing, a receptacle is pivotally mounted to the cover between a folded position and an unfolded position. The storage module can be set in a storage configuration, cover closed and receptacle folded inside the housing, or in a deployed configuration, cover open and receptacle unfolded allowing the user to easily grab an object stored in the receptacle. The storage configuration requires minimal height in the overhead module and the deployed configuration provides maximum accessibility.

This application claims the benefit under 35 U.S.C. §119(a) of European Patent Application EP101690083.2, filed on Jul. 9, 2010, the entire disclosure of which is hereby incorporated by reference.

### TECHNICAL FIELD OF INVENTION

The present invention relates to a vehicle overhead console comprising a receptacle in which can be stored an object such as eyeglasses

### BACKGROUND OF INVENTION

Overhead console of the aforementioned type exist in vehicles so a user, such as the driver, can easily take or put away a pair of eyeglasses. The difficulty in designing an overhead console resides in the necessary optimum compromise to be achieved. The console must be robust, easy to open and to close with one hand, the content must be easy to reach, the object has to be safely stored and, the overall package should be minimal.

In U.S. Pat. No. 6,276,737 B1 Cansfield et al. disclose an overhead console comprising a storage member that deploys when opening. The storage member has one aperture upwardly oriented when the console is closed. Its deployment is the result of a downward translation followed by rotation so the aperture is presented toward the driver.

This console is complex in design requiring multiple components to manage independently the translation and the rotation. Furthermore, when in a closed position, the storage member is upwardly oriented in the console thus requiring an important height in the console.

In US 2007/0133217 A1 Tiesler et al. disclose an overhead module comprising a housing closed by a pivoting door, and a storage compartment fixed to the internal side of the door so, when opening the door the user can take the object that is in the storage compartment. When closed the door is horizontal and, when open the door is vertical, the storage compartment having one open side oriented upward.

Relative to U.S. Pat. No. 6,276,737 B1, Tiesler's storage compartment requires less packaging space in closed position. The issue is to grab a stored object in the interior of the storage compartment in an open position. The vehicle driver has to enter the hand/fingers through the upwardly oriented open side while still seated.

It is important to propose to the market an overhead console solving afore mentioned problems in term of design simplification, minimal volume in closed position, and maximal accessibility when in open position.

### SUMMARY OF THE INVENTION

It is an object of the present invention to provide an overhead console that maintains a high degree of functionality within a compact design, and consisting of exceptionally few individual parts convenient to assemble.

In carrying out the above object and other objects, features, and advantages, the present invention provides an overhead console assembly.

Specifically, the present invention is related to an overhead console for a vehicle interior, comprising a storage module provided with a housing having an aperture, a cover pivotally mounted on the housing about a first axis between a closed position and an open position with regard to the aperture, a receptacle mounted on the cover so that in closed position the receptacle is inside the housing being inaccessible to a user and, in open position the receptacle is outside the housing being accessible to a user. The receptacle is pivotally mounted to the cover about a second axis, parallel to the first axis, between a folded position wherein the receptacle is in abutment against the cover and an unfolded position wherein the receptacle is rotated away from the cover. The storage module can be set in a storage configuration, the cover being in closed position and the receptacle being in folded position inside the housing, retaining an object stored in the receptacle. It can be set as well in a deployed configuration, the cover being in open position and the receptacle being in unfolded position open upwardly and toward the user to allow the user to grab more easily said object. Thanks to this, the storage configuration requires minimal height in the overhead module and the deployed configuration provides maximum accessibility.

Furthermore, the overhead console may comprise a driving device so the rotation of the cover about the housing drives the rotation of the receptacle about the cover. Thus, the deployed configuration can advantageously be obtained by just actuating the cover toward the open position.

In a first embodiment, the driving device comprises a lever extending from a third axis fixed to the housing to a fourth axis fixed to the receptacle. The lever is pivotally mounted about the third axis and the fourth axis that are parallel to the first axis and the second axis. A first distance between the third axis and the fourth axis is longer than a second distance between the first axis and the second axis such that, in closed position, a first line joining the first axis to the second axis is intersecting with a second line joining the third axis to the fourth axis and, in open position, the first line and the second line are not intersecting.

The receptacle advantageously comprises a support wall that, in deployed configuration, is substantially horizontal, the stored object being on it.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

The present invention is now described by way of example with reference to the accompanying drawings in which:

FIG. 1 is a general view of the overhead console and a storage module, as per the present invention. The storage module is in a deployed configuration and a pair of eyeglasses is placed in a receptacle.

FIG. 2 is a side view of the console of FIG. 1 in a storage configuration. A sketch of the kinematic is superposed to the view.

FIG. 3 is a side view of the console of FIG. 1 in intermediate position. A sketch of the kinematic is superposed to the view.

FIG. 4 is a side view of the console of FIG. 1 in the deployed configuration of FIG. 1. A sketch of the kinematic is superposed to the view.

FIG. 5 is an exploded view of the console according to an embodiment provided with a driving device.

### DETAILED DESCRIPTION OF INVENTION

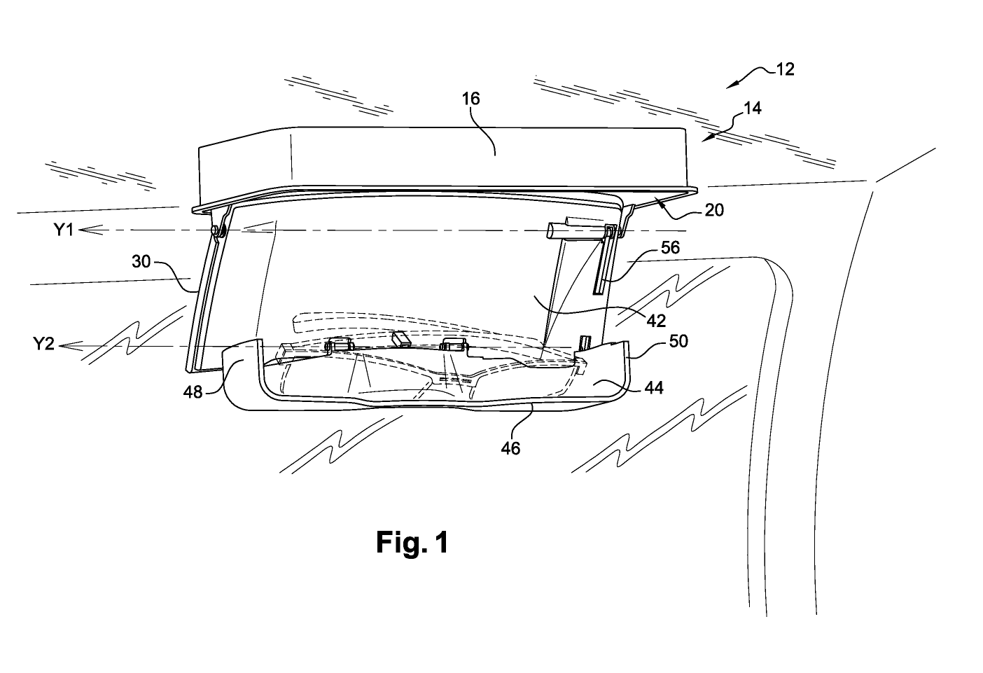

In the following description, similar elements could be designated with the same reference numbers. Also, as presented in FIG. 1, to facilitate the understanding of the description, the various elements of the present invention are placed relative to a vehicle in a standard direct orthogonal axes system (X, Y, Z) where,

X is the longitudinal horizontal axis of the vehicle frontwardly oriented,

Y is the transversal horizontal axis oriented from the right to the left,

Z is the vertical axis upwardly oriented, and

RY is a rotation about the transversal axis Y.

In a motor vehicle 10, FIG. 1 illustrates an overhead console 12 comprising a storage module 14 where an occupant of the vehicle has placed a pair of eyeglasses. Other objects, such as a wallet, can be placed in the storage module 14. Generally, the storage module 14 is fixed to the roof of the vehicle between the front occupants, in the vicinity of the windshield. To access the storage module 14 the occupants have to raise their hands above their heads.

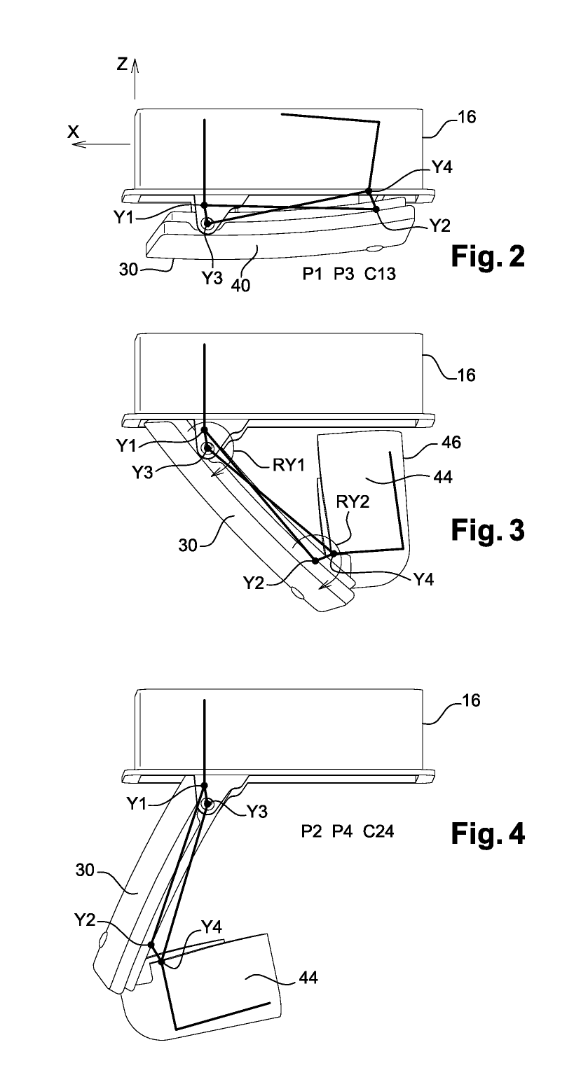

The storage module 14 of the present invention comprises a housing 16 defining an inside volume that is accessible through a horizontal aperture 20 downwardly oriented. The inside volume is above the aperture 20. The aperture 20 can be closed thanks to a cover 30 pivotally mounted relative to the housing 16 about a first transversal axis Y1. Thus, the cover 30 is able to pivot as per a first rotation RY1, between a closed position P1 (FIG. 2) where it is horizontal sealing the aperture 20, and an open position P2 where it is substantially vertical (FIG. 4).

In the closed position P1, the cover 30 as its outer face 40 downwardly oriented visible to the occupants of the motor vehicle 10, and its inner face 42, opposite the outer face 40, upwardly oriented inside 18 the housing 16.

In the open position P2, the outer face 40 is frontwardly oriented, hardly visible to the vehicle occupants, and the inner face 42 is backwardly oriented, easily visible to the vehicle occupants.

As presented on the figures, the aperture 20 and the cover 30 often have rectangular shapes, the angles of which may be sharp or rounded. Furthermore, the aperture 20 and the cover 30 in closed position P1 are described horizontal while the cover 30 in open position P2 is presented vertical after a rotation at right angle 90°. Similarly, one can easily understand that these orientations are chosen to ease and not to limit the description. Other orientations and angular amplitudes are possible.

The storage module 14 further comprises a receptacle 44 delimiting a volume within which can be stored a pair of eyeglasses. The receptacle 44 has a support wall 46 from the edges of which extend perpendicularly a pair of lateral walls 48, 50, and a bottom wall 52. The bottom wall 52 has a transversal free edge 54 about which the receptacle 44 is pivotally mounted on the inner face 42 of the cover 30, about a second transversal axis Y2.

The receptacle 44 is able to rotate about the second axis Y2, according to a second rotation RY2 between a folded position P3 wherein the support wall 46 is parallel to the cover 30 (FIG. 2), and an unfolded position P4 wherein the support wall 46 is substantially normal to the cover 30 (FIG. 4).

The overall dimensions of the receptacle 44 are smaller than the aperture 20 so, the receptacle 44 can pass through the aperture 20 when pivoting the cover 30 back and forth between the closed position P1 and the open position P2.

In the closed position P1, the receptacle 44 is in the folded position P3 enclosed inside the housing 16 (FIG. 2), the pair of eyeglasses being safely secured between the cover 30 and the walls of the receptacle 44.

The shape of the receptacle 44 may depart from the above description. For example, the joining areas between the support wall 46 and the lateral walls 48, 50 and bottom wall 52 may be sharp or rounded as in the Figures. Also, the support wall 46 may be shaped so the object for which it is dedicated is best maintained. A receptacle 44 designed for a wallet may have a flat support wall 46 while for eyeglasses a small central bump for placing the area of the nose may be provided (FIG. 1).

Also, the second rotation RY2 is described to enable the receptacle 44 to pivot at right angle 90° between the folded position P3 and the unfolded position P4. Other angular amplitudes are of course possible smaller or larger than the right angle. For instance, FIG. 4 represents the unfolded receptacle 44 with angular amplitude smaller than 90°.

The overall actuation of the storage module 14 is now described.

In combining the first rotation RY1 and the second rotation RY2 the storage module 14 takes various configurations between a storage configuration C13 (FIG. 2) wherein the cover 30 is in closed position P1 and the receptacle 44 is in folded position P3, and a deployed configuration C24 (FIG. 4) wherein the cover 30 is in open position P2 and the receptacle 44 is in unfolded position P4.

An advantage of the present invention resides in the storage C13 and in the deployed C24 configurations. Indeed, in storage configuration C13, the stored object is well secured inside the housing 16. The storage configuration C13 takes a minimal height in the roof module thus not protruding prominently in the vehicle interior. When in deployed configuration C24, the receptacle 44 comes downwardly toward the occupants, thus offering an easy access to the object. The occupants do not have to raise hands up to the roof as the receptacle 44 is brought down to them by the cover 30.

The storage module 14 is further provided with a locking-unlocking device (not represented) that maintains the cover 30 closed when in storage configuration C13 and that allows the deployment of the receptacle 44 when activated. The locking device may be of any known type such as a push-pull actuation button integrated in the cover 30.

To commute back and forth between the deployed configuration C24 and storage configuration C13, the storage module 14 may be provided with an actuation device that generates the rotational movements RY1 and RY2 in the required direction. Such an actuation device (not represented) may for instance comprise an electrical motor or, for manual actuation, springs actuated in torsion or compression or magnetic devices exercising forces between the housing 16 and the cover 30 and between the cover 30 and the receptacle 44.

Furthermore, the first and second rotations RY1, RY2, may advantageously be set dependent upon each other thanks to a driving device. With such a driving device, when pivoting the cover 30 through the first rotation RY1, the driving device engages the second rotation RY2 pivoting the receptacle 44.

Now, is described an embodiment for the driving device, understanding that other embodiments are possible.

The driving device comprises a lever 56 that extends from a first extremity 58 pivotally mounted relative to the housing 16 about a third transversal axis Y3, to a second extremity 60 pivotally mounted relative to the receptacle 44, about a fourth transversal axis Y4. Thus, the receptacle 44 is linked to the housing 16 via the cover 30 between the first axis and the second axis Y1, Y2, and also via the lever 56, between the third axis and the fourth axis Y3, Y4. The first axis and third axis Y1, Y3, both on the housing 16, are close together, and the second axis and the fourth axis Y2, Y4, both on the receptacle 44, are also close together. The inter-axial distance from first to second axis Y1, Y2, is slightly shorter than the inter-axial distance from third to fourth axis Y3, Y4. As illustrated in FIG. 2, in storage configuration C13, the third axis Y3 is below the first axis Y1, while the fourth axis Y4 is above the second axis Y2, the straight line joining the first axis to the second axis Y1, Y2, intersecting the straight line joining the third axis to the fourth axis Y3, Y4.

The kinematic of this arrangement, as illustrated in the sequence of FIGS. 2, 3 and 4, relies in the trapezoid set by the four transversal axis Y1, Y2, Y3, Y4, being angularly deformable while the lengths remain constant. These combinations of rotations result in the deployment, or the folding, of the receptacle 44.

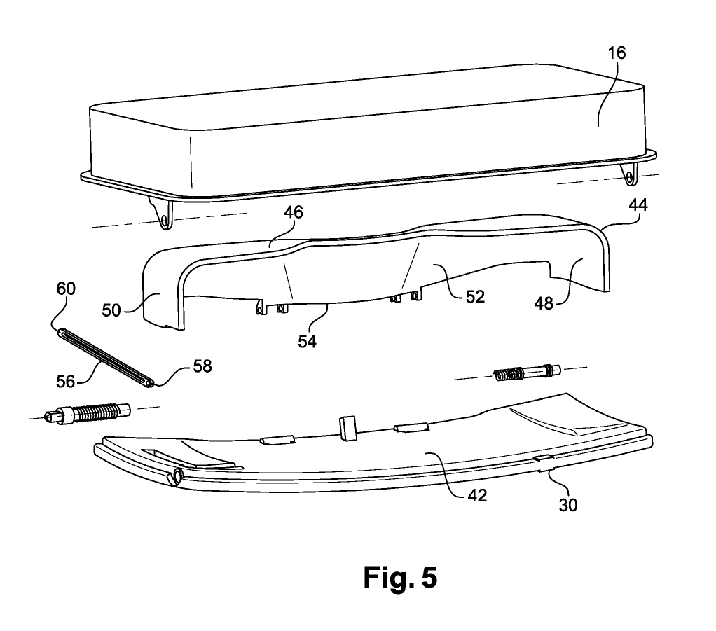

In FIG. 5, the embodiment is presented with a single lever 56. Alternatively to the straight lever 56, other shapes are possible. Also, for symmetry and rigidity purposes, additional levers may be added symmetrically to the lever 56 about the storage module 14.

Alternatively the driving device may comprise a gear wheel pivotally mounted on the cover 30 and engaging with a first worm gear coaxial to the first axis Y1 and fixed to the housing 16 and with, a second worm gear fixed to the receptacle 44 and coaxial to the second axis Y2.

A first rotation RY1 of the cover 30 obliges the gear wheel to rotate, engaging the second worm gear in a rotation RY2 thus, obliging the receptacle 44 to rotate about the cover 30.

While this invention has been described in terms of the preferred embodiments thereof, it is not intended to be so limited, but rather only to the extent set forth in the claims that follow.

We claim:

1. An overhead console for a vehicle interior having a storage module, said overhead console comprising:
a housing having an aperture;
a cover pivotally mounted on the housing about a first axis between a closed position and an open position with regard to the aperture; and
a receptacle mounted on the cover so that in the closed position the receptacle is inside the housing being inaccessible to a user and, in the open position the receptacle is outside the housing being accessible to the user;
wherein, the receptacle is pivotally mounted to the cover about a second axis, parallel to the first axis, between a folded position wherein the receptacle is in abutment against the cover and an unfolded position wherein the receptacle is rotated away from the cover so that, the storage module can be set in a storage configuration, the cover being in the closed position and the receptacle being in the folded position inside the housing to retain an object stored in the receptacle and, can be set as well in a deployed configuration, the cover being in the open position and the receptacle being in the unfolded position open upwardly and toward the user to allow the user to grab said object more easily.

2. The overhead console of claim 1, wherein the overhead console further comprises a driving device so that rotation of the cover about the housing drives rotation of the receptacle about the cover so that the deployed configuration can be obtained by actuating the cover toward the open position.

3. The overhead console of claim 2, wherein the driving device comprises a lever extending between a third axis fixed to the housing and a fourth axis fixed to the receptacle, the lever being pivotally mounted about the third axis and about the fourth axis, the third axis and the fourth axis being parallel to the first axis and the second axis.

4. The overhead console of claim 3, wherein a first distance between the third axis and the fourth axis is longer than a second distance between the first axis and the second axis such that, in the closed position, a first line joining the first axis to the second axis is intersecting with a second line joining the third axis to the fourth axis and, in the open position, said first line and said second line are not intersecting.

5. The overhead console of claim 1, wherein the receptacle comprises a support wall that, in the deployed configuration, is substantially horizontal, a stored object being on said support wall.
